(19) United States
(12) Patent Application Publication
(10) Pub. No.: US 2024/0273558 A1
(43) Pub. Date: Aug. 15, 2024

(54) COMPUTING NETWORKS, ARCHITECTURES AND TECHNIQUES FOR PROCESSING USER-SOURCED DATA IN CHANNEL EVENTS

(71) Applicant: Surge Tech, LLC, Austin, TX (US)

(72) Inventors: Michael Love, Marble Falls, TX (US); Blake Love, Austin, TX (US); Tiago Soromenho, Austin, TX (US); Alexander Starks, Austin, TX (US); Matthew Paff, Round Rock, TX (US)

(21) Appl. No.: 18/110,215

(22) Filed: Feb. 15, 2023

(51) Int. Cl. G06Q 30/0202; G06Q 10/04; G06Q 30/0204

(52) U.S. Cl. CPC G06Q 30/0202; G06Q 10/04; G06Q 30/0205

(57) ABSTRACT

A computerized method comprising: receiving channel events comprising (a) user-sourced data provided by users each using a respective mobile device within a channel and (b) location data associated with the respective mobile devices of the users with the channel; generating a correlation between the location data and the user-sourced data; and generating, using a predictive engine, channel analysis data for the channel based on the channel events and the correlation between the location data and the user-sourced data. Other embodiments are disclosed herein.

### TECHNICAL FIELD

This disclosure is related to computing networks, architectures, and techniques for processing user-sourced data in channel events, as well as systems, methods, and techniques for the same.

### BACKGROUND

Conventional approaches to detecting surges of demand generally are based on detecting an increase in requests for an offering in a particular area. For example, a ride-share company may have an application used by its users, and the ride-share company may detect an increase in requests for rides in a particular area, and can associate that increase in requests with an increase in demand. Based on detecting that increase of demand, the ride-share company may alter pricing for rides in that area for a given time or while demand remains elevated.

Such conventional approaches are reactionary to the single factor of an increase in requests, and fail to incorporate other factors and sources of data that can provide a more holistic determination of the nature and extent of the surge in demand.

### BRIEF DESCRIPTION OF DRAWINGS

To facilitate further description of the embodiments, the following drawings are provided, in which like references are intended to refer to like or corresponding parts, and in which:

FIG. 1A is a diagram of an exemplary system according to certain embodiments;

FIG. 1B is a block diagram illustrating exemplary features of a user-sourced analytics platform according to certain embodiments;

FIG. 2 is a portion of a display screen showing a single-dimensional slider;

FIG. 3 shows a portion of a display screen showing a two-dimensional slider;

FIG. 4 shows a portion of a display screen showing a multi-dimensional slider;

FIG. 5A is a block diagram illustrating examples of channel events, according to certain embodiments;

FIG. 5B is a block diagram illustrating exemplary channel analysis data, according to certain embodiments;

FIG. 5C is a block diagram illustrating examples of user-sourced data, according to certain embodiments;

FIG. 6 is a block diagram of an exemplary client system according to certain embodiments;

FIG. 7A is block flow diagram illustrating an exemplary training phase or training state of the one or more predictive models of FIG. 1B in accordance with certain embodiments;

FIG. 7B is block flow diagram illustrating an exemplary deployment phase or deployment state of the predictive models of FIG. 1B in accordance with certain embodiments;

FIG. 8A illustrates is a block diagram illustrating predictive models that can be trained in the model training stage of FIG. 7A;

FIG. 8B illustrates is a block diagram illustrating predictive models that can be deployed by predictive engines in the model deployment stage of FIG. 7B; and

FIG. 9 is a flowchart illustrating an exemplary method according to certain embodiments.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

The terms “upper,” “lower,” “left,” “right,” “front,” “rear,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the systems, methods, and/or articles of manufacture described herein are, for example, capable of operation in other orientations than those illustrated or otherwise described herein.

### DETAILED DESCRIPTION OF EXEMPLARY EMBODIMENTS

The present disclosure relates to systems, methods, apparatuses, and computer program products that utilize user-sourced data in channel events to dynamically determine or predict channel analysis data. For example, channel events can originate from, or be associated with, a given channel, such as a geographic area. The channel analysis data can be generated by a predictive engine and can be based on the channel events and the correlation between the location data and the user-sourced data. For example, the channel analysis data can include demand information within the channel. In some embodiments, this demand information can be used to execute a demand adjustment function to adjust the price or inventory allocation of one or more inventory items. In certain embodiments, a user-sourced analytics platform can be used to incorporate the channel events, determine the correlation between location data and user-sourced data, and generate the channel analysis data.

The channel events can generally include any data relating to individuals located within a channel, activities occurring within the channel, and/or other conditions associated with the channel. For example, in some embodiments, the channel events for the channel can include data indicating locations or movements of individuals (or mobile devices operated by individuals) within the channel. The channel events also can include data relating to transactions conducted within the channel, weather conditions within the channel, merchants located within the channel, and events (e.g., concerts, conventions, sporting games, etc.) occurring with the channel. The channel events can include user-sourced data, such as data entered by users who are using a mobile device within the channel. Such mobile devices can provide an application that allow the users to enter the user-sourced data. For example, an application provided by a client system can be used by the users to enter user-sourced data. The channel events also can include other data, such as location data associated with the mobile devices of the users with the channel. The location data and the user-sourced data can be correlated to associate the users with location information. The channel events can include many additional attributes related to the channel itself and/or users within the channel. Further examples of channel events are described throughout this disclosure.

In some embodiments, the location data can include information about the location of mobile devices within the channel, information about the establishments (e.g., restaurants, retailers, hotels, etc.) within the channel, vertical categorizations (e.g., residential, hotel, healthcare, retail, etc.) of the establishments within the channel, one or more rankings of individuals within the channel based on their use of establishments or verticals within the channel, other suitable location data, or suitable combinations thereof.

The user-sourced data can include various different types of data that can be entered by a user of a mobile device. For example, a user can enter demographic data, psychographic data, user-preference data, user-transaction data, user-feedback data, such as reasons for actions taken or not taken by the user, and/or other suitable types of user-sourced data. The user-sourced data can be input in some cases using sliders, such as single- or multi-dimensional sliders, which can allow users to input preferences on a sliding scale. In a number of embodiments, the user-sourced data can be used to generate or further build out user profiles for the users.

The channel analysis function can be configured to analyze or process the channel events, and generate channel analysis data for the channel. The channel analysis data generated can vary. The channel analysis data for the channel can include various metrics relating to the channel itself, individuals within the channel, and/or activities occurring within the channel. For example, the channel analysis data can indicate or predict the supply and/or demand within the channel for one or more products or services (e.g., riding sharing, hotel accommodations, parking garages, dining availability, sporting or event tickets, etc.). The channel analysis data also can identify or predict increases and/or decreases in the number of individuals within the channel, as well as intra-channel and inter-channel movements of those individuals. The channel analysis data can include many other metrics related to the channel, individuals in the channel, and/or activities occurring within the channel. Further examples of channel analysis data are described throughout this disclosure.

The channel analysis data generated can include real-time analysis information that provides current or up-to-date data relating to the aforementioned metrics and/or other metrics. The channel analysis data can be generated based on the channel events, including at least the user-sourced data, and the correlation between the location data and the user-sourced data. The channel analysis data also can include predictive analysis information that predicts a future status of the aforementioned metrics and/or other metrics. Examples of these real-time and predictive analytics are provided throughout this disclosure.

In some embodiments, the channel analysis data can be used to execute one or more demand adjustment functions. Additionally, or alternatively, the channel analysis data can be provided to one or more client systems that utilize the channel analysis data to execute the one or more demand adjustment functions. One exemplary demand adjustment function can include a pricing function that determines prices for one or more inventory items. For example, in some cases, the channel analysis data can be utilized by a surge pricing function to dynamically adjust prices for one or more inventory items in a manner that accounts for the supply and demand for the one or more inventory items. Another exemplary demand adjustment function includes an inventory management function that utilizes the channel analysis data to manage or adjust inventories (e.g., such as to dynamically reallocate inventory items among channels and/or initiate ordering of additional inventory items). In many embodiments, the demand adjustment function can factor in the channel analysis data that takes into account user-sourced data, such as preferences of the users in the channel.

The channel analysis data can be utilized to execute one or more deployment functions that enable the channel analysis data to be utilized for a variety of purposes. In some scenarios, a deployment function can be executed to automate pricing systems (e.g., surge pricing systems) and/or inventory systems based on the channel analysis data. For example, the channel analysis data can be interfaced with pricing and inventory applications operated by one or more client systems (e.g., third-party systems) to automatically adjust the pricing of inventory (e.g., products or services) and/or automatically reallocate or reorder inventory based on the supply and demand metrics associated with the channel and/or based on the increases or decreases of individuals within the channel.

In another example, a deployment function can be executed to transmit notifications that include some or all of the channel analysis data. For example, notifications can be transmitted to client systems affiliated with merchants within the channel to disseminate real-time data and/or predictive data relating to the supply and demand of particular products or services. The merchant notifications also can include other information included in the channel analysis data (e.g., population surge information, event information, transaction patterns within the channel, movement patterns of individuals with the channel, etc.). Notifications also can be transmitted to individuals within the channel (e.g., to present offers or discounts to the individuals and/or recommend merchants located in the channel). Additional types of deployment functions are described throughout this disclosure.

The technologies described herein can provide a variety of benefits and advantages. Amongst other things, the use of user-soured data and predictive technologies can predict conditions in the channels with greater accuracy and precision, including conditions pertaining to the demand with the channel, at various establishments within the channel, or across various verticals in the channel. For example, in some instances, the prediction model can consider the demographics, psychographics, preferences, feedback, etc. of users to determine individualized inclinations or propensities of users within a given channel, and/or predict inclinations or propensities of other individuals within the channel, to compute real-time demand predictions for a given channel. The increased accuracy and precision of these demand predictions can be attributed, at least in part, to the granular, individualized predictions generated for each of the these individuals, which leverages user-sourced data from users of mobile devices within the channel.

Further benefits can be attributed to the usefulness and versatility of the channel analysis data, which can be leveraged for many different purposes. For example, in some scenarios, the demand predictions can be utilized by client systems to automate pricing functions and/or inventory functions in real-time or near real-time based on the current conditions within the channels. Additionally, the demand predictions can be utilized by client systems to prepare for predicted future conditions within the channels. In some cases, the client systems can be interfaced with a user-sourced analytics platform (e.g., via an application programming interface or API) to enable immediate access to the demand predictions on a continuous basis, thereby facilitating a seamless adjustment of pricing and/or inventory allocations in real-time or near real-time. This data can provide merchant entities with real-time and/or predictive metrics that can assist merchant entities with accommodating surges in supply and demand (and/or population surges within a channel).

Additional benefits can be attributed to embodiments that utilize the demand predictions to automate surge pricing functions. Client applications that employ surge pricing functionalities can better mitigate imbalances between an available supply of inventory items and a demand for those inventory items. The demand predictions can be leveraged to dynamically adjust prices for the inventory items, thereby enabling providers of the client applications to reduce high-demand peaks.

Other benefits can be attributed to the versatility of the technologies described herein, which can be leveraged to improve operations in any establishment or in any vertical. That is, the location tracking and predictive technologies can be applied to predict current and/or future supply and demand conditions for any establishment or vertical. Exemplary verticals that can benefit from these technologies can include those related to ride hailing services, transportation (e.g., ticket bookings for buses, trains, airplanes, cruises, boats, etc.), lodging accommodations (e.g., affiliated with hotels, motels, short-term home stays, rental services, property purchases, etc.), parking services (e.g., affiliated with parking garages, parking lots, etc.), restaurant services, tavern services, entertainment services, etc. For example, the technologies disclosed herein can provide vertical-specific or merchant-specific insights and metrics regarding the current and future demand for products and services offered in these verticals or by these entities. These metrics can be used by those entities to automatically or manually adjust settings for pricing systems (e.g., surge pricing systems), inventory systems, and/or other operations. By using user-sourced information from users in the channel, and/or extrapolating information more generally about other individuals in the channel based on the user-sourced information, the insights and metrics provided to specific merchants and/or in specific verticals can be more accurate.

The embodiments described in this disclosure can be combined in various ways. Any aspect or feature that is described for one embodiment can be incorporated to any other embodiment mentioned in this disclosure. Moreover, any of the embodiments described herein may be hardware-based, may be software-based, or, preferably, may comprise a mixture of both hardware and software elements. Thus, while the description herein may describe certain embodiments, features, or components as being implemented in software or hardware, it should be recognized that any embodiment, feature and/or component referenced in this disclosure can be implemented in hardware and/or software.

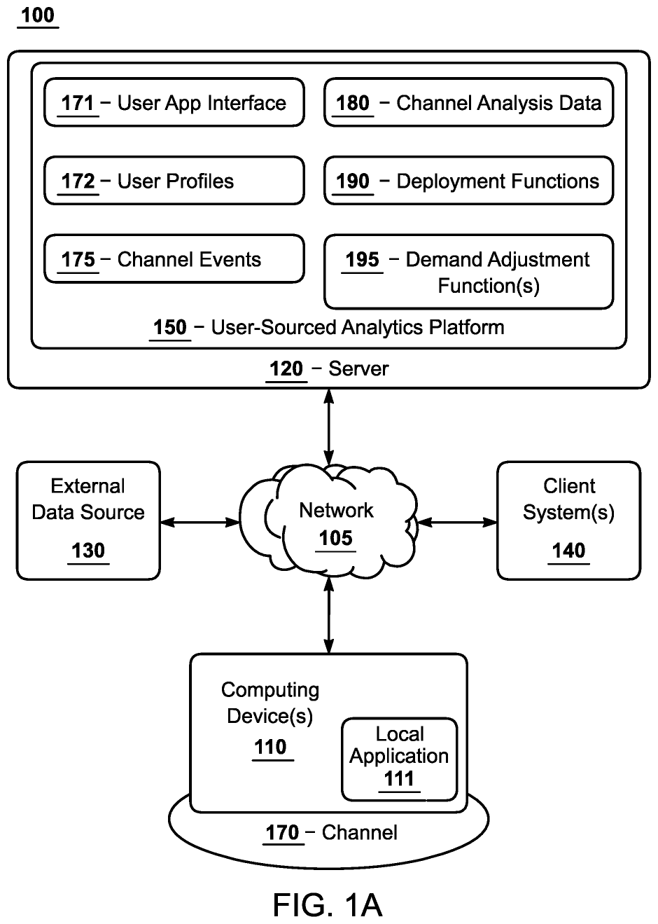

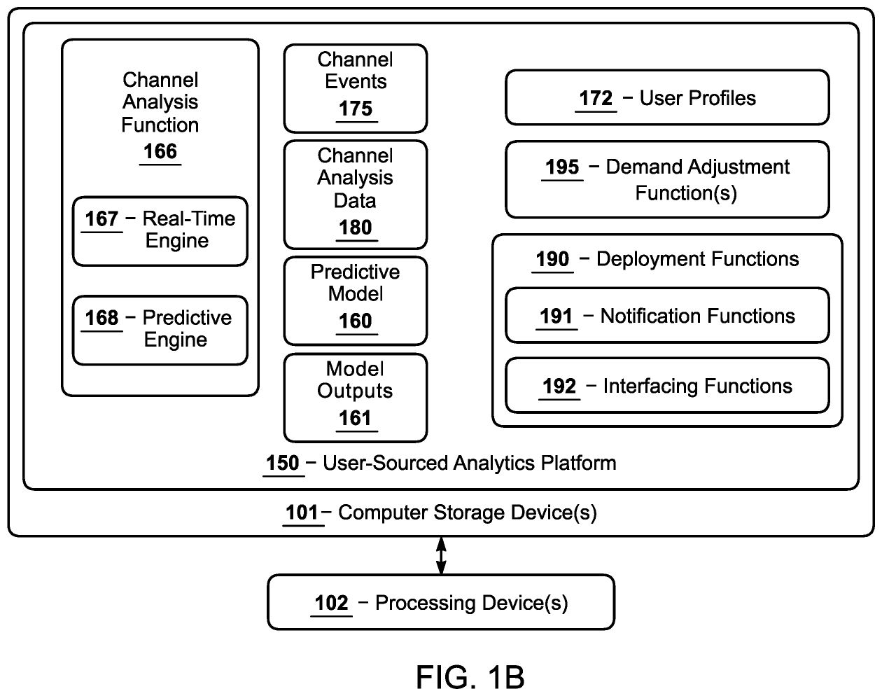

FIG. 1A is a diagram of an exemplary system 100 in accordance with certain embodiments. The system 100 includes, inter alia, a user-sourced analytics platform 150 that generates or derives channel analysis data 180 for a channel 170. FIG. 1B is a diagram illustrating additional features, components, and/or functions associated with the user-sourced analytics platform 150. FIGS. 1A and 1B are jointly discussed below.

The system 100 comprises one or more computing devices 110, one or more servers 120, one or more external data sources 130, and one or more client systems 140 that are in communication over a network 105. User-sourced analytics platform 150 is stored on, and executed by, the one or more servers 120. The network 105 may represent any type of communication network, e.g., such as one that comprises a local area network (e.g., a Wi-Fi network), a personal area network (e.g., a Bluetooth network), a wide area network, an intranet, the Internet, a cellular network, a television network, and/or other types of networks.

All the components illustrated in FIG. 1A, including the one or more computing devices 110, one or more servers 120, one or more external data sources 130, and one or more client systems 140, and user-sourced analytics platform 150 can be configured to communicate directly with each other and/or over the network 105 via wired or wireless communication links, or a combination of the two. Each of the computing devices 110, servers 120, external data sources 130, client systems 140, and user-sourced analytics platform 150 can include one or more communication devices, one or more computer storage devices 101, and one or more processing devices 102 (FIG. 1B) that are capable of executing computer program instructions.

The one or more computer storage devices 101 may include (i) non-volatile memory, such as, for example, read only memory (ROM) and/or (ii) volatile memory, such as, for example, random access memory (RAM). The non-volatile memory may be removable and/or non-removable non-volatile memory. Meanwhile, RAM may include dynamic RAM (DRAM), static RAM (SRAM), etc. Further, ROM may include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In certain embodiments, the one or more computing storage devices 101 may be physical, non-transitory mediums. The one or more computer storage devices 101 can store, inter alia, instructions associated the implementing the functionalities of the user-sourced analytics platform 150 described herein.

The one or more processing devices 102 may include one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions. The one or more processing devices 102 can be configured to execute any computer program instructions that are stored or included on the one or more computer storage devices 101 including, but not limited to, instructions associated the implementing the functionalities of the user-sourced analytics platform 150 described throughout this disclosure.

Each of the one or more communication devices can include wired and wireless communication devices and/or interfaces that enable communications using wired and/or wireless communication techniques. Wired and/or wireless communication can be implemented using any one or combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware can depend on the network topologies and/or protocols implemented. In certain embodiments, exemplary communication hardware can comprise wired communication hardware including, but not limited to, one or more data buses, one or more universal serial buses (USBs), one or more networking cables (e.g., one or more coaxial cables, optical fiber cables, twisted pair cables, and/or other cables). Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.). In certain embodiments, the one or more communication devices can include one or more transceiver devices, each of which includes a transmitter and a receiver for communicating wirelessly. The one or more communication devices also can include one or more wired ports (e.g., Ethernet ports, USB ports, auxiliary ports, etc.) and related cables and wires (e.g., Ethernet cables, USB cables, auxiliary wires, etc.).

In certain embodiments, the one or more communication devices additionally, or alternatively, can include one or more modem devices, one or more router devices, one or more access points, and/or one or more mobile hot spots. For example, modem devices may enable some or all of the computing devices 110, servers 120, external data sources 130, client systems 140, and/or user-sourced analytics platform 150 to be connected to the Internet and/or other network. The modem devices can permit bi-directional communication between the Internet (and/or other network) and the computing devices 110, servers 120, external data sources 130, client systems 140, and/or user-sourced analytics platform 150. In certain embodiments, one or more router devices and/or access points may enable the computing devices 110, servers 120, external data sources 130, client systems 140, and/or user-sourced analytics platform 150 to be connected to a LAN and/or other more other networks. In certain embodiments, one or more mobile hot spots may be configured to establish a LAN (e.g., a Wi-Fi network) that is linked to another network (e.g., a cellular network). The mobile hot spot may enable the computing devices 110, servers 120, external data sources 130, client systems 140, and/or user-sourced analytics platform 150 to access the Internet and/or other networks.

In certain embodiments, the computing devices 110 may represent desktop computers, laptop computers, mobile devices (e.g., smart phones, personal digital assistants, tablet devices, vehicular computing devices, wearable devices, or any other device that is mobile in nature), and/or other types of devices. The one or more servers 120 may generally represent any type of computing device, including any of the aforementioned computing devices 110. The one or more servers 120 also can comprise one or more mainframe computing devices and/or one or more virtual servers that are executed in a cloud-computing environment. In some embodiments, the one or more servers 120 can be configured to execute web servers and can communicate with the computing devices 110, external data sources 130, client systems 140, and/or other devices over the network 105 (e.g., over the Internet).

In certain embodiments, the user-sourced analytics platform 150 can be stored on, and executed by, the one or more servers 120. Additionally, or alternatively, the user-sourced analytics platform 150 can be stored on, and executed by, the one or more computing devices 110 and/or one or more client systems 140. The user-sourced analytics platform 150 can be stored on, and executed, by other devices as well.

In some embodiments, the user-sourced analytics platform 150 also can be stored as a local application 111 on a computing device 110, or interface with the local application 111 stored on a computing device 110, to implement the techniques and functions described herein. The computing device 110 may be part of client system 140 in some scenarios. In many embodiments, local application 111 can be provided by a client system 140 or an entity associated with client system 140.

The client systems 140 can generally correspond to third-party systems, networks, and/or devices that access the user-sourced analytics platform 150 and/or utilize the data (including the channel analysis data 180) generated by the user-sourced analytics platform 150. For example, the client systems 140 can be operated and managed by platform users, such as individuals, businesses, and/or other entities, which can utilize the user-sourced analytics platform 150 (including the channel analysis data 180 generated by the user-sourced analytics platform 150) to improve the functionalities of one or more systems and/or one or more applications.

In certain embodiments, each of the client systems 140 can register and/or create a platform user account with the user-sourced analytics platform 150 to obtain access to the data and services provided by the user-sourced analytics platform 150. The client systems 140 can be operated by, or associated with, individuals or businesses from any industry or vertical including, but not limited, to those that offer ride hailing services, hotel or lodging accommodations, parking space availability, tavern services, and restaurant services. As explained in further detail below, the client systems 140 can utilize the channel analysis data 180 (and other data provided by the user-sourced analytics platform 150) to enhance and improve business operations in various ways.

Each of the client systems 140 may include one or more computing devices 110 that enable the client systems 140 to access the user-sourced analytics platform 150 over the network 105. In some cases, one or more of the client systems 140 may include sophisticated technological infrastructures, such those that include enterprise systems, servers 120, virtual private networks (VPNs), intranets, etc. The computing devices 110, servers 120, and/or other devices associated with each client system 140 can store and execute various applications (e.g., such as ride hailing applications, lodging booking applications, dining reservation applications, pricing applications, inventory management applications, etc.). The client systems 140 and associated applications can leverage the data (e.g., channel analysis data 180) provided by the user-sourced analytics platform 150 in various ways.

In certain embodiments, the user-sourced analytics platform 150 can be integrated with (or can communicate with) various applications hosted by the client systems 140 including, but not limited to, applications that provide products or services for transportation services (e.g., ride hailing services, ride sharing services, vehicle rental services, and/or ticket scheduling services for buses, trains, planes, boats, and/or other modes of transportation), lodging accommodations (e.g., booking services for hotels, motels, short-term home stays, rental services, property purchases, etc.), parking space services (e.g., booking services for parking garages, parking lots, etc.), and scheduling services (e.g., reservation services for restaurants, bars, sporting events, concerts, ticketed events, etc.). In certain embodiments, the user-sourced analytics platform 150 additionally, or alternatively, can be integrated with (or can communicate with) e-commerce applications, pricing applications, inventory management applications, and/or other applications.

The aforementioned applications and/or other applications, each of which may be integrated or interfaced with the user-sourced analytics platform 150, can be stored on one or more client systems 140 in some embodiments. For example, the aforementioned applications and/or other applications can stored be stored on one or more computing device 110 and/or one or more servers 120 associated with one or more client systems 140.

As discussed throughout this disclosure, the user-sourced analytics platform 150 can generally provide functions associated with analyzing conditions associated with activities, individuals, events, and/or like within each of a plurality of channels 170. This analysis can be used to generate channel analysis data 180 corresponding to each of the channels 170. The channel analysis data 180 for a given channel 170 can include various metrics and information useful for understanding and/or predicting the conditions within the channel 170. For example, the channel analysis data 180 for the channel 170 can include information that indicates and/or predicts population surges within the channel 170, movements of individuals within the channel, and/or supply and demand for inventory (e.g., products or services) within the channel 170. Additionally, as described in further detail below, the user-sourced analytics platform 150 can utilize the channel analysis data 180 to implement a surge pricing function and/or inventory management function on a variety of client applications.

Each channel 170 can represent, or correspond to, a specific geographic region or area. The scope or region associated with each channel 170 can vary significantly. For example, macro-level channels 170 can correspond to large geographic areas covering entire continents, countries, and/or states. Other more micro-level channels 170 can correspond to counties, cities, and/or towns. Additional channels 170 can correspond to specific regions, neighborhoods, areas, or the like within cities or towns. Regardless of geographic scope, server 120 can be associated with a channel 170 to process data associated with the channel 170 and generate channel analysis data 180 for the channel 170.

In many embodiments, the computing devices 110 (e.g., mobile devices, smart phones, wearable devices, etc.) can be operated by users within the channels 170. Each of the computing devices 110 can store and execute a location application 111. These users can use the local application 111, which can be a mobile application, a web-based application, or another suitable application running on computing device 110. The local application 111 can be associated with, and/or provided by, the entity associated with client system 140. For example, a merchant or hospitality provider can provide a mobile application or a web-based application to users, such as a shopping app or loyalty app. In other embodiments, the local application 111 can be associated with, and/or provided by, an entity that operates the user-sourced analytics platform 150. In some cases, the local application 111 can be a plug-in associated with, and/or provided by, an entity that operates the user-sourced analytics platform 150 and that works with another application associated with, and/or provided by, the entity associated with client system 140 that is running on computer device 110 of the user. In many embodiments, the local application 111 can provide a way for the user-sourced analytics platform 150 to obtain direct information from users.

The user-sourced analytics platform 150 can include a user app interface 171, which can be used to interface with, communicate with, or otherwise obtain, user-sourced data from local application 111. For example, the user app interface 171 can be a web server, application server, or a function that provides similar functionality. In some examples, the user-sourced analytics platform 150 can obtain the user-sourced data via the client system 140 obtaining the user-sourced data from local application 111, and the client system 140 providing the user-sourced data to the user-sourced analytics platform 150 through user app interface 171. In other examples, the user app interface 171 of the user-sourced analytics platform 150 can obtain the user-sourced data directly without passing through client system 140. In some cases, the client system 140 can filter, edit, summarize, redact, or otherwise alter the amounts, the types, the content, or other aspects of the user-source data that is provided to the user app interface 171 via client system 140. For example, some user-sourced data can be sensitive proprietary information that the client system 140 does not share with the user-sourced analytics platform 150, and such information can be filtered out, summarized, edited, or otherwise handled to prevent certain information from being shared from the client system 140 to the user-sourced analytics platform 150. The user-sourced data is one of the types of channel events 175, and the user-sourced data is further described below in association with user-sourced data 503.

The types and content of the channel events 175 received and processed can vary. The channel events 175 can generally include any data associated with monitoring locations of individuals (including the users and others) within the channel 170, activities occurring within the channel 170, and/or other conditions associated with the channel 170. For example, the channel events 175 can include data indicating locations of individuals (or their smart phones or mobile devices) within the channel 170, transactions conducted within the channel 170, weather conditions within the channel, and/or events (e.g., concerts, conventions, etc.) occurring within the channel 170.

The channel events 175 can be generated by, or received from, various devices, systems, and/or sources. Some of the channel events 175 can be generated by computing devices 110 (e.g., mobile devices, smart phones, wearable devices, etc.) operated by individuals within the channels 170, such as the user-sourced data from users using the local application 111 on computing device 110. For example, these devices (or applications installed thereon) can generate channel events 175 indicating locations of the devices, transactions conducted using the devices, and/or other information.

Additional channel events 175 can be received one or more external data sources 130, which can include third-party websites, databases, and/or servers that provide information relating to the channels 170 and/or individuals located within the channels 170. Exemplary external data sources 130 can include websites, databases, and/or servers associated with cellular device providers, weather outlets, news outlets, social media sites, and/or the like. In some embodiments, these and other external data sources 130 be used to derive or generate channel events 175 relating to weather conditions within the channels 170, events occurring with the channel, locations of individuals within the channels, etc.

In many embodiments, the channel events 175 can include various types of location data. For example, the location data can include data indicating locations or movements of individuals (or mobile devices operated by individuals), such as the users or others, within the channel. The location data also can include data relating to establishments (e.g., merchants, restaurants, retailers, hotels, etc.) within the channel. The location data additionally can include vertical categorizations (e.g., residential, hotel, healthcare, retail, etc.) of the establishments within the channel. The location data further can include one or more rankings of individuals within the channel based on their use of establishments or verticals within the channel.

The user-sourced analytics platform 150 can correlate the location data and the user-sourced data to associate particular users with location information. For example, the location information can indicate that a particular device has been used regularly at certain locations, at certain establishments, or at certain verticals, and this information can be associated with a particular user. When combined with user-sourced data for the user, the user-sourced analytics platform can provide invaluable feedback and insights about users and actions within the channel 170.

The user-sourced analytics platform 150 can use the user-sourced data to generate or store additional information to user profiles 172 about the users. For example, the user-sourced analytics platform 150 can create or store a user profile 172 for each user for which user-sourced data is obtained. The user profiles 172 can store information about the user, such as demographic information about the user, psychographic information about the user, preferences of the user, transactions made by the user, feedback provided by the user, and/or other suitable information. In many cases, the user profiles can include location information that has been correlated to the user, which can provide information about locations and movements of the user in the channel, use of establishments or verticals by the user, and/or other suitable information. In some cases, the user-sourced analytics platform 150 can aggregate, summarize, or otherwise synthesize user-sourced data about a user and store such data to the user profile for the user. For example, if a user shows a preference for luxury vehicles across multiple transactions, the user profile can include information about this user preference. Additionally, or alternatively, if the user provides user-sourced data through the local application 111 expressly indicating that the user prefers luxury vehicles, that information can be stored in the user profile. The preferences of a user in the user profile can be updated as additional information is obtained about the user, such as different preference information obtained through the user-sourced data or through different transaction patterns recognized for the user.

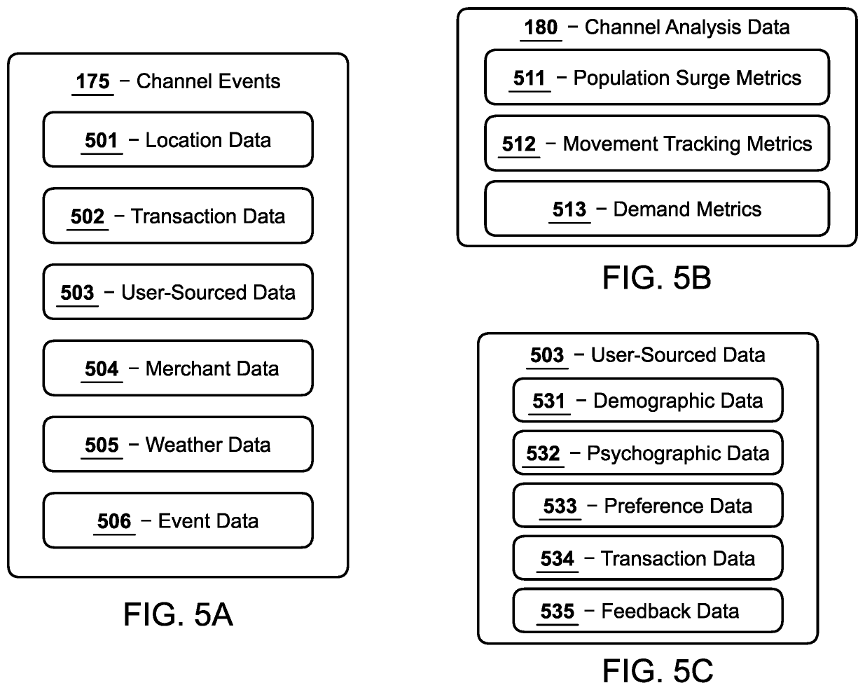

FIG. 5A is a block diagram illustrating examples of channel events 175 that can be received by the user-sourced analytics platform 150. As shown, the channel events 175 can include, inter alia, location data 501, transaction data 502, user-sourced data 503, merchant data 504, weather data 505, and event data 506.

The location data 501 can indicate the current locations and/or historical locations and movements of individuals (or computing devices 110 operated by individuals), such as the users of local application 111 or other individuals, located in the channel 170. For example, the location data 501 may include GPS coordinates indicating the current locations of individuals, and previous locations of those individuals. In some embodiments, the location data 501 can be received directly from computing devices 110 operated by the individuals (e.g., users) and/or an external data source 130, such as a cellular service provider.

The transaction data 502 can indicate purchases that are made within the channel 170 and/or purchases made by individuals that are currently located within the channel 170. The transaction data 502 also may indicate transaction patterns or profiles for each of the individuals located in the channel 170 (e.g., indicating the types of products or services routinely purchased by the individual and/or the types of businesses routinely frequented by the individual). In some cases, the transaction data 502 also may indicate the channel 170 where each transaction was conducted. In some embodiments, the transaction data 502 can be received directly from computing devices 110 operated by the individuals and/or an external data source 130, such as a third-party merchant system, credit card service provider, digital payments provider, etc.

The user-sourced data 503 received can include information provided by the users of computing devices 110 using the local application 111. Some or all of this information can be stored in the user profiles 172. FIG. 5C, described below, shows some examples of user-sourced data 503 that can be received by the user-sourced analytics platform 150.

The merchant data 504 can provide information related to merchants (e.g., businesses, vendors, etc.) or establishments located in the channel 170. For example, the merchant data 504 may identify the locations of the merchants, the vertical associated with the merchants, hours of operation, and products or services offered by the merchants. In some embodiments, the merchant data 504 can be received directly from computing devices 110 operated by the merchants and/or an external data source 130, such as a crowd-sourced business review applications, business information databases, etc.

The weather data 505 can indicate the current weather conditions and/or historical weather conditions in the channel 170. The weather data 505 also may indicate forecasts of future weather conditions for the channel 170. In some embodiments, the weather data 505 can be received from one or more external data sources 130, such as those that provide weather forecasting services.

The event data 506 can provide information associated with events (e.g., concerts, conventions, seminars, shows, etc.) in the channel 170. The event data 506 can include information identifying ongoing events, as well as previously held or upcoming events. The event data 506 may include dates and times associated with each of the events. In some embodiments, the event data 506 can be received directly from computing devices 110 operated by event providers and/or an external data source 130, such as a social media sites, community bulletin board sites, etc.

The categories identified in FIG. 5A are intended to provide examples of content that may be included in channel events 175. However, it should be recognized that the channel events 175 can include additional information or data related to the activities, individuals, entities, and/or conditions of the channel 170.

FIG. 5C is a block diagram illustrating examples of user-sourced data 503 that can be received by the user-sourced analytics platform 150. As shown, the user-sourced data 503 can include, inter alia, demographics data 531, psychographic data 532, preference data 533, transaction data 534, and feedback data 535.

In some embodiments, the user-sourced data 503 can be received from computing devices 110 operated by the users. For example, the local application 111 running on computing devices 110 can ask the user questions, or prompt the user to fill out a form in the local application 111. In some cases, the local application 111 can present options for the user to select to provide the information, such as types of genders, or income brackets. In some cases, the local application 111 can present one or more sliders, which can be used by the user to enter user-sourced data 503, such as preference data 533, as described below in further detail. In some cases, the user can receive a reward, such as loyalty points or a store credit, for providing the user-sourced data 503. The local application 111 can send the user-sourced data 503 to user-sourced analytics platform 150 through user app interface 171, which in some cases can be via client systems 140.

The demographic data 531 for each user can indicate some or all of the following: age, sex, gender, race, ethnicity, income, marital status, housing status, home address or location, employment status, occupation, education level, income level, etc.

The psychographic data 532 for each user can indicate some or all of the following: interests, values, attitudes, interests, lifestyles, behaviors, opinions, beliefs, activities, etc.

The preference data 533 for each user can indicate various different preferences of the user. For example, a user may generally prefer luxury vehicles over economy vehicles when placing an order with a ride hailing service, and may be willing to pay for such luxury vehicles up to a certain point. As another example, a user may prefer to pay with points (e.g., rewards points) and prefer to see prices in points instead of the local currency. As a further example, a user may prefer electric vehicles or vehicles with a lower environmental impact. As yet another example, a user may be willing to share a ride with other users.

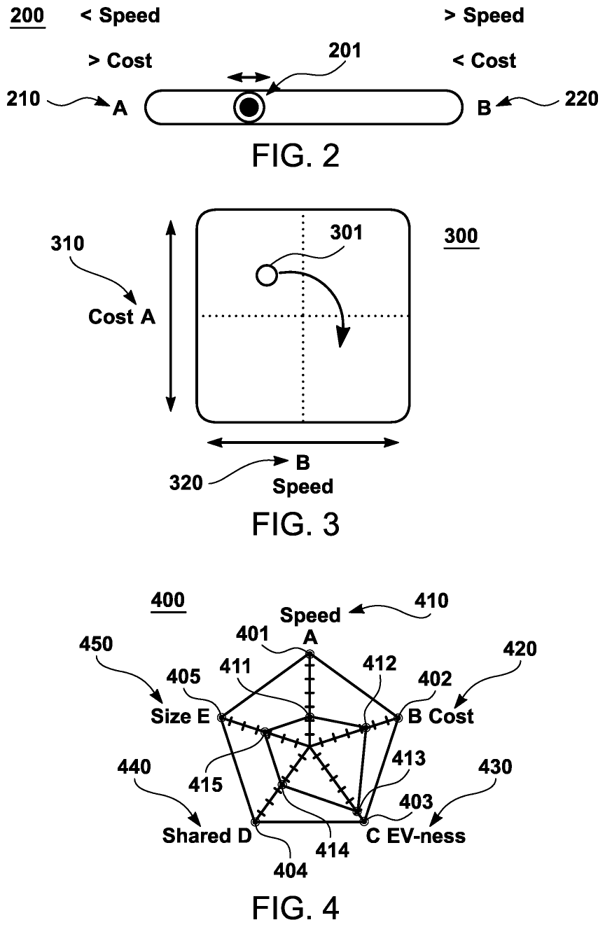

In many cases, the local application 111 can present one or more sliders, which can be used by the user to enter user-sourced data 503, such as the preference data 533. Examples of sliders are shown in FIGS. 2-4. For example, FIG. 2 shows a portion of a display screen that can be provided by the local application 111. The display screen in FIG. 2 shows a single-dimensional slider 200, which allows a sliding element 201 to be manipulated between a first end associated with a first label 210 and a second end associated with a second label 220. For example, as shown in FIG. 2, the first label 210 can be “<speed” or “slower”, and the second label 220 can be “>speed” or “faster”. As part of the same example, as shown in FIG. 2, or as a separate example, the first label 210 can be “>cost” or “more cost-conscious”, and the second label 220 can be “<cost” or “less cost-conscious”. The user can slide sliding element 201 along a continuum between the two ends to indicate how strongly the user prefers speed, even in the face of increased cost, or prefer lower cost, despite longer waits.

FIG. 3 shows a portion of a display screen that can be provided by the local application 111. The display screen in FIG. 3 shows a two-dimensional slider 300, which allows a sliding element 301 to be manipulated within a two-dimensional grid associated with a first axis associated with a first label 310 and second axis associated with a second label 320. For example, as shown in FIG. 3, the first label 310 can be “cost”, and the second label 320 can be “speed”. The user can move slider element 301 within the grid of two-dimensional slider 300 to indicate how strongly the user cares about cost, and how strongly the user cares about speed. Because cost and speed are merely two factors involved, if the user select a strong preference for low cost and a strong preference for high speed, the user may end up taking a trade-off in other areas, such as quality (an economy vehicle instead of a luxury vehicle).

FIG. 4 shows a portion of a display screen that can be provided by the local application 111. The display screen in FIG. 4 shows a multi-dimensional slider 400, which allows five sliding elements 411-415 to be slid along five different sliding scales between a center 406 and ends 401-405, respectively, which are associated with labels 410, 420, 430, 440, and 450, respectively. For example, as shown in FIG. 4, the first label 410 can be “speed” (indicating preference for speed), the second label 420 can be “cost” (indicating cost-consciousness), the third label 430 can be “EV-ness” (indicating preference for electric vehicles (EVs)), the fourth label 440 can be “shared” (indicating preference or willingness to have a shared accommodation), and the fifth label 450 can be “size” (indicating preference for size). The user can move each of slider elements 411-415 within the sliding scales between the center 406 and ends 401-405, respectively, to indicate how strongly the user cares about the particular area of preference.

Returning to FIG. 5C, the transaction data 534 for each user can include information about purchases or other transactions made by the user. For example, the transaction data 534 can include information about purchases made by the user through the local application 111, and are known to the local application 111 on that basis. Additionally or alternatively, the transaction data 534 can include information provided by users through the local application 111 about purchases the user has made, such as purchases made outside the local application 111. The transaction data 534 also may indicate transaction patterns or profiles for the user (e.g., indicating the types of products or services routinely purchased by the user and/or the types of businesses routinely frequented by the user).

The feedback data 535 for each user can include information entered by the user either as free-form feedback, or in response to prompts for feedback, through the local application 111. For example, the user can be prompted to provide reasons for actions taken or not taken by the user. To illustrate, if a user was presented with an offer at an establishment (e.g., a hotel room for a certain price) through the local application 111, and the user declined the offer, the local application 111 can ask the user to provide reason(s) for not accepting the offer. For example, the local application 111 can present selectable options or check boxes next reasons, such as “too expensive”, “not enough options”, “not relevant”, etc. As another example, the local application 111 can ask the user what would have made the user accept the offer and close the deal.

The categories identified in FIG. 5C are intended to provide examples of user-sourced data 503. However, it should be recognized that the user-sourced data 503 can include additional information or data provided by the users of computing devices 110 within the channel 170.

Returning to FIGS. 1A and 1B, the channel events 175 associated with the channel 170 can be received by user-sourced analytics platform 150. The user-sourced analytics platform 150 can execute a channel analysis function 166 to analyze the channel events 175, and generate channel analysis data 180 for the channel 170. The channel analysis data 180 can include various types of metrics or data useful for understanding the conditions associated with the channel 170. In many scenarios, the channel analysis data 180 can include real-time information regarding the current channel conditions and/or predictions related to future channel conditions.

FIG. 5B is a block diagram illustrating examples of channel analysis data 180 that can be generated by the user-sourced analytics platform 150. In some embodiments, the channel analysis function 166 executed by user-sourced analytics platform 150 may generate channel analysis data 180 that includes population surge metrics 511, movement tracking metrics 512, and demand metrics 513.

The population surge metrics 511 generated by user-sourced analytics platform 150 can detect occurrences or situations in which the number of users and/or other individuals located within the channel 170 (or certain regions in the channel 170) significantly increases and/or decreases. In some embodiments, the population surge metrics 511 can include data that identifies densities of users and/or other individuals throughout the channel 170. For example, the population surge metrics 511 can indicate regions within the channel 170 where there is a high density of users and/or other individuals and/or regions within the channel where there are lower densities of users and/or other individuals. In some cases, the population surge metrics 511 for a channel 170 can be generated, at least in part, by monitoring locations (e.g., GPS coordinates) of users' and/or other individuals' computing devices 110 (e.g., smart phones or mobile devices), determining the number of computing devices 110 that are located within the channel 170 (or region within the channel), and comparing that number to a value indicating an average or baseline population for the channel 170 (or region within the channel).

The user-sourced analytics platform 150 also can be configured to predict future channel conditions in which the population in the channel 170 will vary from the average or baseline population. These predictions can be generated based, at least in part, on an analysis of the channel events 175. For example, the event data 506 included in the channel events 175 can be utilized to identify times and locations in which a population surge is likely to occur in the channel 170 (or regions within the channel 170) as the result of an upcoming event (e.g., such as a concert). Additionally, or alternatively, the location data 501 included in the channel events 175 can be used to predict upcoming expansions or retractions of populations within a channel 170 (or regions within a channel 170) based on an analysis of users' and/or other individuals' current locations and/or based on historical movement patterns. Additionally, or alternatively, the weather data 505 included in the channel events 175 also may be utilized to predict the population surge metrics 511 based on expected weather conditions for future time periods. Additionally, or alternatively, the user-sourced data 503 can be used to predict population surge metrics 511, such as by determining users that will likely participate in an upcoming event, or would likely use an establishment after a currently occurring event ends. Such determinations can be based on user-sourced data 503.

The movement tracking metrics 512 can include various metrics indicating and/or predicting the locations or movements of users and/or other individuals within the channel 170. The movement tracking metrics 512 can include data indicating where users and/or other individuals have moved within the channel, and locations where those users and/or other individuals originated. The movement tracking metrics 512 also include data that indicates movement or migration patterns of users and/or other individuals (both intra-channel movement patterns and inter-channel movement patterns). For example, based on an analysis of historical location data 501, the movement tracking metrics 512 may indicate historical movement patterns of users and/or other individuals within the channel 170.

The movement tracking metrics 512 also can include data that predicts the movements of users and/or other individuals throughout a channel 170 in a future time period. For example, the movement tracking metrics 512 can predict regions within a channel where individuals are likely like to migrate. The movement tracking metrics 512 can be generated based, at least in part, on the channel events 175 (e.g., such as the location data 501 indicating current and historical locations of individuals, user-sourced data 503, and event data 506 indicating current or upcoming events within the channel 170).

The demand metrics 513 can include various metrics indicating and/or predicting supply and/or demand within the channel 170 for various inventory items (e.g., products and/or services) at one or more establishments or in one more verticals (e.g., riding sharing, hotel accommodations, parking garages, restaurants, bars, retail, etc.). The current or future supply and/or demand for inventory may be determined based, at least in part, on an analysis of the population surge metrics 511 (e.g., which can indicate or predict the densities of users and/or other individuals within the channel 170 or regions within the channel 170). Additionally, or alternatively, the supply and/or demand for inventory also may be based on an analysis of channel events 175 received by the user-sourced analytics platform, such as channel events that include user-sourced data 503 (e.g., users preferring speed over cost-consciousness), transaction data 502 (e.g., which may indicate recent or historical purchases made within the channel 170), weather data 505 (e.g., which may indicate weather conditions affecting the demand for inventory), merchant data 504 (e.g., which may indicate the supply of inventory in the channel 170), the correlations of the location data and the user-sourced data 503 (e.g., the history of a user utilizing certain establishments or verticals in view of the user's preferences), and/or other channel events 175.

The population surge metrics 511, movement tracking metrics 512, and demand metrics 513 are provided as examples of channel analysis data 180. However, it should be recognized that the channel analysis data 180 can include many other types of metrics or analytics relevant to the conditions of the channels 170.

Returning to FIGS. 1A and 1B, the one or more computing devices 110 can enable individuals to access the user-sourced analytics platform 150 over the network 105 (e.g., over the Internet via a web browser application). For example, after a platform user account is established with the user-sourced analytics platform 150, a platform user (e.g., an individual associated with a client system 140 or other individual) may utilize the user-sourced analytics platform 150 to access to channel analysis data 180 generated by the user-sourced analytics platform 150. In some embodiments, the platform user may be provided with access to the channel analysis data 180 generated across all of the channels 170. In other embodiments, the platform user may designate particular channels 170 of interest and receive channel analysis data 180 from the designated channels 170. In some embodiments, the platform user also may designate particular verticals or industries of interest, and receive channel analysis data 180 pertaining specifically to those verticals or industries.

The user-sourced analytics platform 150 may generate various graphical user interfaces (GUIs) that display the channel analysis data 180 and/or other associated data (e.g., channel event information, user profiles 172, account profiles for the platform user, etc.), and these interfaces can be accessed via the platform user accounts. The interfaces provided by the user-sourced analytics platform 150 also can include selectable options for configuring one or more deployment functions 190. The deployment functions 190 can permit platform users to leverage the channel analysis data 180 (and other data generated by the user-sourced analytics platform 150) for various purposes.

One exemplary deployment function 190 can include a notification function 191. The notification function 191 enables users to configure the transmission of notifications in various scenarios. The notifications can be transmitted in various ways (e.g., via e-mail, cellular text messages, inbox messages on platform user accounts, data presented on GUIs, etc.) and the notifications can be sent to various devices (e.g., client systems 140, mobile or computing devices operated by individuals located in a channel 170, etc.).

Another exemplary deployment function 190 can include an interfacing function 192. The interfacing function 192 can permit a platform user to interface the user-sourced analytics platform 150 with various external applications and/or systems, thereby enabling those applications and/or systems to receive and utilize the channel analysis data 180 generated by the user-sourced analytics platform 150.

In some embodiments, one or more of applications running on, or operated by, the client systems 140 can be directly interfaced with the user-sourced analytics platform 150 (e.g., via an application programming interface or API provided by the user-sourced analytics platform 150). In some exemplary scenarios, an client system 140 may execute or provide a ride hailing application, a lodging booking application (e.g., hotel booking application), a dining reservation application (e.g., an application for scheduling dining reservations), a ticket booking application (e.g., for purchasing tickets to concerts, sporting games, and/or other events), a pricing application (e.g., an program that computes or determines prices for products and/or services), a staffing application (e.g., a program that schedules employees), and/or an inventory management application (e.g., a program that allocates inventory among different channels 170 or locations, places orders for new inventory, etc.). The interfacing function 192 can connect the user-sourced analytics system 150 to these applications (and other types of applications), thereby enabling the applications to directly receive the channel analysis data 180 and utilize the channel analysis data 180 to automate control of one or more functions (e.g., such as determining or adjusting pricing information, adjusting inventory allocations, initiating purchases of additional inventory, adjusting staffing at locations, etc.).

In one example, the deployment functions 190 can be utilized to implement surge pricing functions, which change or adjust the prices of products and/or services based on a supply or demand for those products and/or services. For example, the population surge metrics 511, movement tracking metrics 512, and/or demand metrics 513 included in the channel analysis data 180 for the channel 170 can be used to dynamically adjust the pricing for hotel rooms, ride hailing services, parking garage spaces, and/or other types of inventory based on the demand for the inventory within the channel 170. In some embodiments, one or more demand adjustment functions 195 can be used to directly adjust, or recommend adjusting, a pricing or resource allocation upon a detected surge. For example, the demand metrics 513 can be used to execute the demand adjustment functions 195. The demand adjustment functions 195 can be executed to adjust prices and/or inventory allocations for one or more inventory items in channels 170 based on the demand metrics 513 generated for the channels 170.

In another example, the deployment functions 190 can be utilized by client systems 140 to reallocate inventory or resources based on the channel analysis data 180. For example, a client system 140 that provides ride-sharing services can reallocate drivers to regions or areas where demand is higher and/or expected to be higher. Along similar lines, a client system 140 that is affiliated with a restaurant within a channel 170 can place orders for additional inventory and/or adjusting staffing in scenarios where demand is higher and/or expected to be higher.

The channel analysis function 166 can include a real-time engine 167 and one or more predictive engines 168 according to certain embodiments. In certain embodiments, the real-time engine 167 and the predictive engine 168 can represent subroutines that are executed by a channel analysis function 166 for the user-sourced analytics platform 150 to generate channel analysis data 180 for the channel 170.

The real-time engine 167 can be configured to generate channel analysis data 180 pertaining to the current or real-time conditions of the channel 170, and the predictive engine 168 can be configured to generate channel analysis data 180 pertaining to predicted conditions of the channel 170 in one or more future time periods. For example, the real-time engine 167 can generate population surge metrics 511, movement tracking metrics 512, and demand metrics 513 indicating the real-time conditions of the channel 170, while the predictive engine 168 can generate population surge metrics 511, movement tracking metrics 512, and demand metrics 513 predicting conditions of the channel 170 in one or more future time periods. The future time periods can be near-term (e.g., the next 1, 2, 3, 4, 5, 6, 7, 8, 9, 10, 15, 20, 25, 30, 45, 60, 90, or 120 minutes), or longer-term. As explained above, the real-time engine 167 and predictive engine 168 can utilize various channel events 175 (e.g., indicating spending habits, schedule events, weather conditions, historical movements of individuals, population density, user-sourced data, etc.) to determine the current and future conditions of the channels.

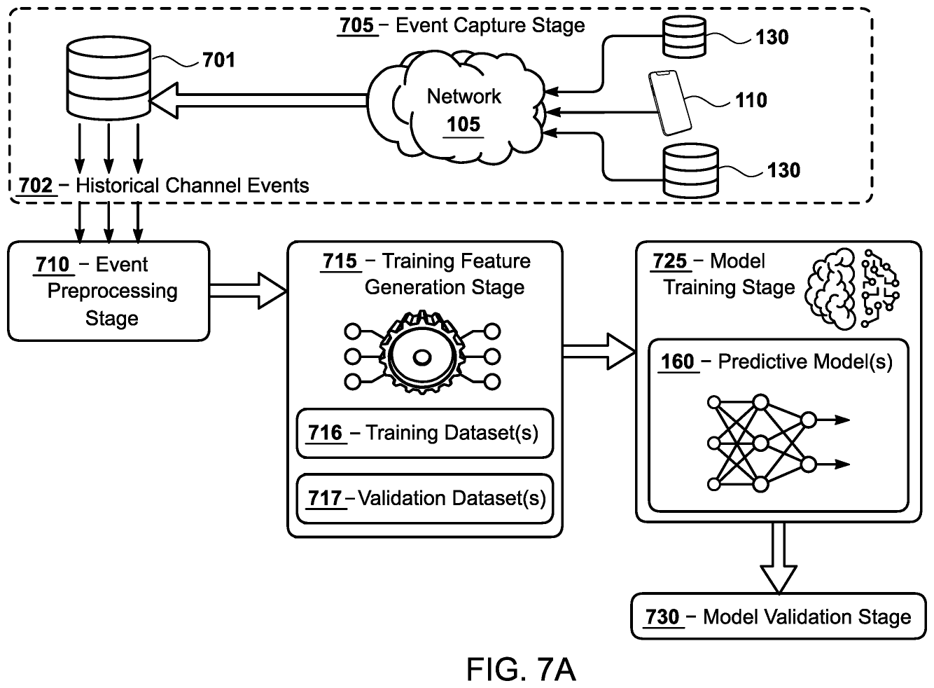

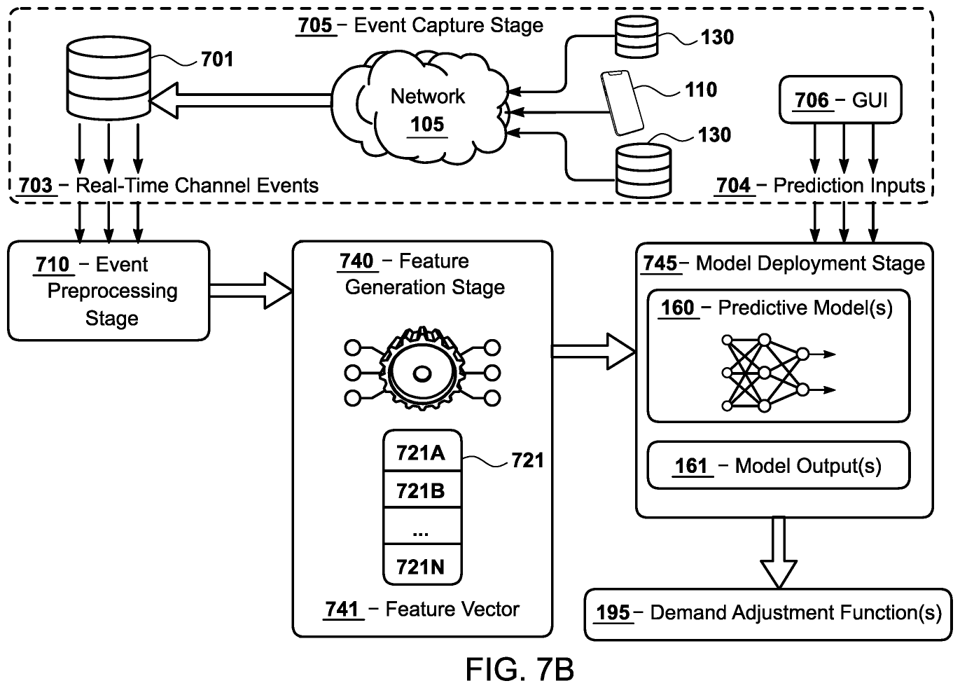

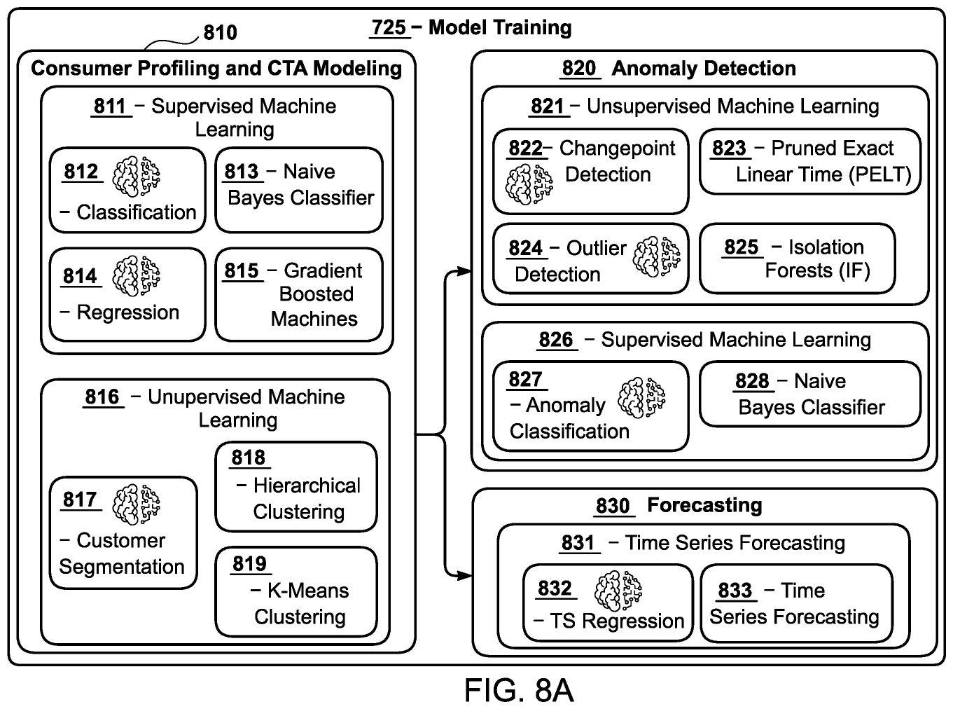

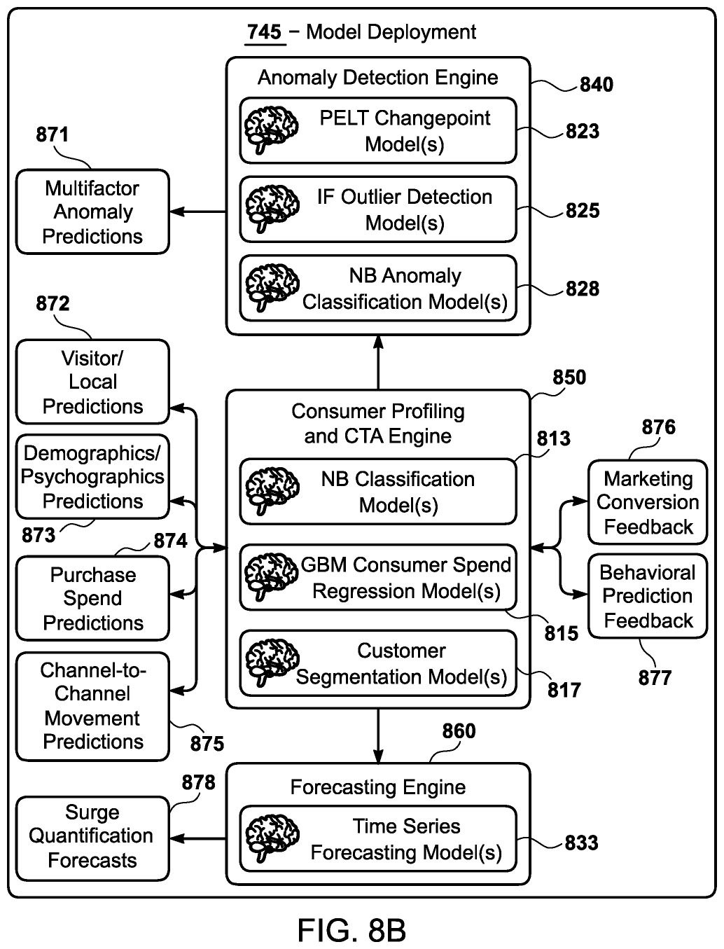

In various embodiments, the predictive engine 168 can utilize one or more predictive model 160 to make predictions. For example, the predictive model 160 can be a machine learning model or another suitable predictive model, which can be trained using historical channel data (e.g., historical channel events, information in the user profiles 172, etc.) pertaining to the channel 170 to generate model outputs 161, such as predictive metrics corresponding to population surges, movement patterns, and/or demand surges at particular establishments or verticals within the channel 170. For example, the predictive model 160 can use inputs of various types of user-sourced data 503, location data 501, event data 506, and/or other channel event 175, and can output a demand metric. The model outputs 161, such as predictive metrics and demand metrics, can be utilized to execute the demand adjustment functions 195 described herein. Additional details regarding predictive model 160, and the training and deployment of predictive model 160 are shown in FIGS. 7A, 7B, 8A, and 8B, and described below. In many embodiments, the model outputs 161 can be included in the channel analysis data 180.

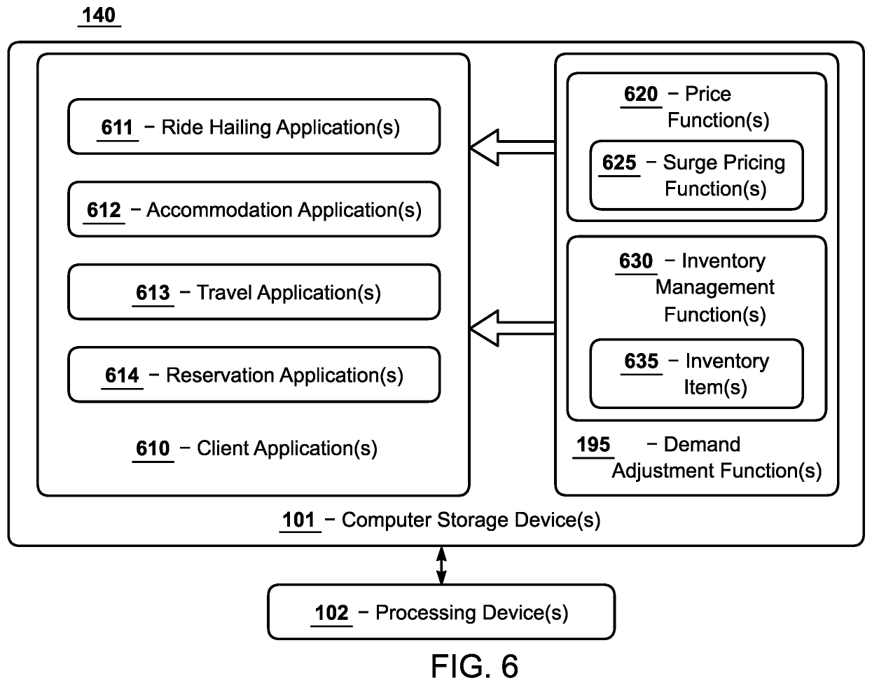

FIG. 6 is a block diagram illustrating exemplary features, components, and/or functions of a client system 140 according to certain embodiments. The client system 140 can include one or computing devices 110 and/or one or more servers 120, each of which includes one or more computer storage devices 101 and one or more processing devices 102. The client system 140 can host and execute one or more client applications 610.

Exemplary client applications 610 provided by a client system 140 can include one or more of the following: 1) a ride hailing application 611 (e.g., an application that connects passengers with drivers to schedule rides); 2) an accommodation application 612 (e.g., an application that permits guests to schedule rooms or lodging); 3) a travel application 613 (e.g., an application that permits individuals to book schedule transportation with airlines, trains, buses, boats, etc.); and 4) a reservation application 614 (e.g., an application that permits individuals to schedule reservations or tickets for restaurants, concerts, events, bars, parking spaces, and/or other venues). Other types of client applications 610 also may be hosted and executed by the client systems 140. In certain embodiments, the client applications 610 can represent web-based applications that are accessible via a web browser and/or local applications (e.g., mobile apps) that is installed on devices (e.g., mobile devices or smart phones) operated by end-users.

The channel analysis data 180 (e.g., the population surge metrics 511, movement tracking metrics 512, demand metrics 513, and/or other data described herein) can be utilized to enhance various functionalities of the client applications 610. In some scenarios, the channel analysis data 180 can be utilized to enhance or implement one or more demand adjustment functions 195, such as a pricing function 620 and/or an inventory management function 630, for each of the client applications 610. The demand adjustment functions 195 can be executed by user-sourced analytics platform 150 in some cases, and can be executed client system 140 in other cases. The demand adjustment functions 195 can be configured to adjust pricing and/or inventory information for inventory items based on actual or predicted supply metrics and/or demand metrics for the inventory items. The pricing function 620 and/or inventory management function 630 can be included with the functionality of each of the client applications 610, or can be included in separate applications that communicate with the client applications 610.

The pricing function 620 can utilize the channel analysis data 180 to determine pricing for one or more inventory items 635, which may generally include any type of product or service made available by a client application. For example, depending on the functionality of a given client application 610, the pricing function 620 can determine pricing for ride hailing services, taxi services, lodging accommodations, event tickets (e.g., for sporting events or concerts), airline tickets, train tickets, packing spaces, etc.

In some scenarios, the channel analysis data 180 can be utilized to implement a surge pricing function 625 for one or more of the client applications 610. A surge pricing function 625 generally represents a function that adjusts the price of one or more inventory items 635 based on the demand for the inventory items 635 (e.g., based on a comparison of the supply and the demand for the inventory items 635). The demand metrics 513 (and/or other channel analysis data 180) generated by the user-sourced analytics platform 150 may be utilized to dynamically adjust the pricing of one or more inventory items 635 offered by each of the client applications 610.

The inventory management function 630 can utilize the channel analysis data 180 to manage or adjust inventory items 635 in various ways. For example, the inventory management function 630 can detect when additional inventory items 635 should be ordered to accommodate a current demand for inventory items 635 and/or a predicted future demand for inventory items 635. In some scenarios, the inventory management function 630 also can be configured to automatically place an order for additional inventory items 635 to accommodate a spike in a current or predicted demand for the inventory items 635.

The inventory management function 630 also can reallocate inventory items 635 to accommodate varying supply and demand metrics across different channels 170 and/or within a given channel 170. For example, in some scenarios, a merchant may have multiple business locations, including multiple locations within a given channel 170 and multiple locations situated outside the channel 170. The inventory management function 630 can utilize the channel analysis data 180 to dynamically reallocate inventory items 635 among the business locations in within the given channel 170 to accommodate the varying demands at those locations and/or to maximize sales of inventory items 635 across all locations. Similarly, the inventory management function 630 can utilize the channel analysis data 180 to dynamically reallocate inventory items 635 from a location in one channel 170 to one or more separate channels in order to accommodate the varying demands in each channel 170 and/or to maximize sales of inventory items 635 across all channels 170.

In certain embodiments, the client applications 610 can additionally, or alternatively, be stored on and executed by the user-sourced analytics platform 150. Similarly, the demand adjustment functions 195 (e.g., including the pricing function 620, the surge pricing function 625, and/or the inventory management function 630) can be stored on and executed by the user-sourced analytics platform 150.

For example, in certain embodiments, user-sourced analytics platform 150 can be utilized to execute the demand adjustment functions 195. In addition to generating the channel analysis data 180, user-sourced analytics platform 150 can execute one or more demand adjustment functions 195 for the channel 170. In one example, user-sourced analytics platform 150 can execute a surge pricing function 625 that utilizes the channel analysis data (e.g., the population surge metrics 511 and/or demand metrics 513) to dynamically adjust the pricing of one or more inventory items 635. In another example, user-sourced analytics platform 150 can execute an inventory management function 630 that dynamically allocates or reallocates inventory items 635 within a channel 170 and/or among a plurality of channels 170.

FIG. 7A is block flow diagram illustrating an exemplary training phase or training state of the one or more predictive models 160 in accordance with certain embodiments. In this training phase, a training procedure can be applied to any of the predictive models 160 described in this disclosure, as well as other learning models not specifically mentioned. As explained below, this training procedure can be varied slightly based on whether a given predictive model 160 is being trained in an unsupervised or supervised fashion.

In broad terms, the training procedure of FIG. 7A can include, inter alia, an event capture stage 705, an event preprocessing stage 710, a training feature generation stage 715, a modeling training stage 725, and a model validation stage 730. For predictive models 160 that are trained in a supervised fashion, the training procedure in FIG. 7A also may include an annotation generation stage (not shown).

In the event capture stage 705, channel events 175 can be received and stored in one or more databases 701, which may include databases 701 that are maintained by, or accessible to, the user-sourced analytics platform 150. At least a portion of the channel events 175 can be received over a network 105 from one or more external data sources 130 and/or computing devices 110 (e.g., mobile devices or smart phones) operated by individuals located in the one or more channels 170. The channel events 175 can be stored and aggregated over a period of time (e.g., one month, six months, a year, etc.) to provide a dataset or collection of historical channel events 702.

In many embodiments, the channel events 175 aggregated and stored in historical channel events 702 can include various types of data. For example, as explained above, the channel events 175 can include various types of data including, but not limited to, location data 501, transaction data 502, user-sourced data 503, merchant data 504, weather data 505, and/or event data 506. The channel data 175 the user-sourced data 503 also can include various types of user input, such as survey data from an email or a mobile application, conversion rate data from targeted advertisements or push notifications, and/or integrated social media data. The channel data 175 can additional other channel-specific data, such as traffic congestion data and historical demand (e.g., footfall) data from within-channel device counts, in addition to weather data 505, event data 506, and user-sourced data 503. The channel data 175 can include points of interest (POI) data, such as address, geolocation, associated POI types (e.g., restaurant, retail, bar), business classification, and historical demand data, as examples. The channel data 175 also can include various data about individual users, such as location data 501, user-sourced data 503, and device-specific metadata (e.g., model or phone, historical geolocation, etc.).

In many embodiments, raw data can be aggregated from heterogeneous sources, such as proprietary third-party data, such as cellular carrier data and weather data, as well as open source data, such as government census and local events. This raw data can be processed via validation, extraction, and normalization pipelines for use in downstream applications, including real-time processes, machine learning prediction(s) and historical data storage. In some embodiments, given the heterogeneous nature of the type(s) of data used (e.g., dynamic, static, historical, etc.), various types of databases can be utilized. For example, structured data can be stored in relational databases, such as PostgreSQL, MySQL, and Oracle. Unstructured data can be stored in NoSQL databases, such as MongoDB and Cassandra. For cases in which data and inter-relationships are captured, Graph databases can be used, such as Neo4j. Time series data can be stored in specialized databases, such as InfluxDB and TimescaleDB.

In the event preprocessing stage 710, various preprocessing operations, including validation, extraction, and normalization operations, can be performed on the historical channel events 702. The historical channel events 702 can be stored as raw data that is accumulated from a variety of heterogeneous sources and stored in a variety of heterogeneous formats. The preprocessing operations applied in this stage can conform the data to a uniform or standardized format is usable for later stages of the training procedure of FIG. 7A.

In the training feature generation stage 715, channel features are extracted and/or derived from the preprocessed historical channel events 702 to generate a training dataset 716 and/or a validation dataset 717. The channel features can correspond to the various types of channel events 175, or other features derived therefrom, such as device geolocations, within-channel device counts, events, surveys, social media, weather conditions, historical data, POIs, user clicks, conversions, etc. Other types of channel features also can be generated. The channel features can be aggregated and split into training dataset 716 and validation dataset 717, to train and test, respectively, the predictive models 160 in the training stage of FIG. 7A. When used in the context of the training procedure of FIG. 7A, the channel features can be referred to as “training channel features” in some portions of this disclosure. Some of the training channel features can be derived by analyzing and transforming the data corresponding to the channel events 175.

In some embodiments, separate groups or sets of training channel features can be extracted that represent the demand conditions in the channel 170 at a given point in time. For example, a first set of training channel features can correspond to the demand conditions in Channel A at Time A, a second set of training channel features can correspond to the demand conditions in Channel A at Time B, a third set of training channel features can correspond to the demand conditions in Channel A at Time C, etc.

In certain embodiments, a separate channel feature vector (or other data structure) can include or store each set of training channel features, and, in some cases, each channel feature vector can be associated with a particular point in time in the channel 170. Thus, in some cases, a training dataset 716 can comprise multiple channel feature vectors that can be used to collectively model or represent the demand conditions in the channel 170 over the course of a specific time period.

The annotation generation stage can be applied to certain training procedures, such as those that use supervised or semi-supervised training techniques. The annotation generation stage can annotate each channel feature vector (or each set of channel features) with a label, which can identify an output (e.g., demand or other prediction) associated with each training feature vector (or each set of channel features). That is, each channel feature vector can include a set of training channel features that represent the conditions for the channel 170 at a given point in time, and the demand indicator label 321 can identify the demand or prediction based on those conditions. In some cases, the demand indicator labels can be appended to, or included in, the feature vectors.

In the model training stage 725, one or more predictive models 160 can be trained (using the training datasets 316 generated in the previous stage) to predict demand metrics 513 for the channel 170. The predictive models 160 can involve analyzing time-series data to identify periods of increased demand. The predictive models 160 can use and/or combines anomaly detection for real-time identification of anomalous changes in channel-level demand (i.e., users) and/or forecasting to predict future levels of demand.

Jumping ahead in the drawings, FIG. 8A illustrates is a block diagram illustrating predictive models that can be trained in the model training stage 725. In many embodiments, a combination of systems of predictive models can work together to provide model outputs 161. For example, the systems of predictive models 160 can include consumer profiling and call-to-action (CTA) models 810, anomaly detection models 820, and forecasting models 830.

The consumer profiling and CTA models 810 can include system of machine learning models that are used to profile individual users as well as provide a point of contact through which to interact with users (e.g., via the local application 111 or email campaign) within the channel 170 for the purpose of fine-tuning the surge models with granular behavioral and psychographic information. The consumer profiling and CTA models 810 can include one or more algorithms, which can be combined to profile users within the channel 170. This system can combine unsupervised and supervised machine learning techniques that are utilized to provide demographic and psychographic information on the users within the channel 170. In addition, the insights and predictions generated from the consumer profiling and CTA models 810 can be used to directly interact with users within the channel 170 to provide a CTA to (1) collect real time feedback from the users to improve the models and (2) incentivize and drive surge through targeted interactions. The consumer profiling and CTA models 810 can include supervised machine learning models 811 and/or unsupervised machine learning models 816.

The unsupervised machine learning models 816 can include one or more customer segmentation models 817. Customer segmentation models 817 can involve identifying and dividing differentiated groups within a population of users based on common characteristics such as demographics or behavioral characteristics. Customer segmentation 817 can utilize hierarchical clustering 818, k-means clustering 819, or other suitable customer segmentation models, such as Density-Based Spatial Clustering of Applications with Noise (DBSCAN), Gaussian Mixture Models (GMMs), and MeanShift clustering, among others.

Hierarchical cluster 818, such as agglomerative hierarchical clustering, involves generating a hierarchical structure of groupings of data points using a “bottom-up” approach. The data points start as individual clusters, with pairs of clusters built as one moves up the hierarchy, with more similar pairs (as defined by a distance metric) grouped together earlier. This method can be used to provide a structure of subgroupings or segments of users that can be used to separate and classify a population of users for granular identification (e.g., business verticals) of specific surge application(s) and prediction.

K-Means clustering 819 is a method for creating distinct clusters of consumers with a defined number (K) of segments. This method is a centroid-based algorithm in which K centroids are identified within the data so as to minimize the distance between each data point and their respective cluster centroid.

Supervised machine learning models 811 can include one or more classification models 812, which can involve binary classification and/or multiclass classification, and which can be used in a variety of use-cases to characterize within-channel users to enhance resolution of surge models. Examples include classification of users as locals vs. tourists, demographics predictions (e.g., profession), and classification of lodging needs. In many embodiments, classification models 812 can utilize Naive Bayes (NB) classifiers 813, which can be used to train binary and multiclass classification models. This method is based on Bayes' theorem and assumes (naive) features are independent given a class label. A probabilistic model is trained from historical data with conditional probabilities assigned to a given class. Additionally, or alternatively, classification models 812 can utilize alternative approaches, such as Convolutional Neural Networks (CNNs), Gradient Boosting Machines (GBM), and Random Forest (RF), among others.

Supervised machine learning models 811 also, or alternatively, can include one or more regression models 814, which can involve utilizing regression analysis to predict potential customer spend, household income, or time at location and/or in channel. Regression models 814 can utilize Gradient Boosting Machines (GBM) 815 to apply to such regression problems. GBM trains a series of small (weak) models in a gradual, additive, and sequential manner that act in ensemble to provide a prediction, which in this case can be used to predict some continuous value (e.g., income, consumer spend, time at location), trained to optimize a specified loss function.

The anomaly detection models 820 can include one or more anomaly detection algorithms, which can be combined to create a system that can detect and identify various anomalous patterns that detect significant changes in within-channel demand. This system combines unsupervised and supervised machine learning techniques that are utilized by the surge application. The anomaly detection models 820 can include unsupervised machine learning models 821 and/or supervised machine learning models 826.

The unsupervised machine learning models 821 can include one or more change point detection models 822 and/or one or more outlier detection models 824. The change point detection models 822 can involve identifying abrupt and significant changes in datasets, such as detecting shifts in trends within a data series. The change point detection models 822 can utilize a PELT (Pruned Exact Linear Time) change point model 823 to identify such shifts in the underlying data through minimization of a cost function over varying numbers and locations of change points within the data. The PELT change point model 823 is able to detect both abrupt and gradual shifts in data. Alternative approaches that can be utilized for change point detection models 822 include binary segmentation, window-based search, Bayesian online change point detection, and sequentially discounting autoregressive (SDAR) models, among others.

The outlier detection models 824 can involve detection of anomalous points, which can identify any data point or observation that significantly deviates from the other observations in the data. The outlier detection models 824 can utilize an Isolation Forests (IF) outlier detection model 825, which can identify such anomalous data points. IF outlier detection model 825 is similar to Random Forests, built based on decision trees in which anomalous points are rare and unique compared to the majority of data. Outliers are identified as they are isolated from fewer branches (closer to the root) and are easier to separate in the tree from the normal data. Alternative approaches that can be utilized for outlier detection models 824 can include Holt-Winters Exponential Smoothing, Density-Based Spatial Clustering of Applications with Noise (DBSCAN), and Bayesian Networks, among others.

The supervised machine learning models 826 can include one or more anomaly classification models 827, which can involve classification of labeled anomalies via supervised or semi-supervised methods, and which can be used to identify pre-identified (or prioritized) anomalies. The anomaly classification models 827 can utilize a Naive Bayes (NB) Classification model 828 to train a one-class classification model to predict probabilities of anomalies from labeled (or partially labeled) historical anomalies. Generally, this algorithm trains a probabilistic model to estimate the conditional probability that an observation is anomalous. Alternative approaches that can be utilized for anomaly classification models 827 can include One-Class Support Vector Machines (OCSVM), Support Vector Data Description (SVDD), and One-Class K-means, among others.

The forecasting models 830 can include one or more time series forecasting models 831, which can be utilized by the system to predict future demand on a per-channel basis. This prediction can be accomplished through modeling consumer demand (e.g., footfall) historically to provide insight into future demand and/or consumer density. The time series forecasting models 831 can include a time series regression model 832 and/or another suitable time series forecasting model, such as GBM, Autoregressive Integrated Moving Average (ARIMA), Seasonal Autoregressive Integrated Moving Average (SARIMA), Autoregressive Recurrent Neural Networks, or Long Short-Term Memory (LSTM), among others. GBM can be used to model historical time series and predict future forecasts. GBM can be used to train an ensemble model to provide a forecast prediction, which in this case can be a forecast for future demand and/or consumer density.

Returning to FIG. 7A, certain predictive models 160, such as supervised or semi-supervised models, such as classification models 812, regression models 814, and anomaly classification models 827, can be trained using the training datasets 716 that are annotated with labels. Other predictive models 160, such as customer segmentation models 817, change point detection models 822, and outlier detection models 824, can be trained in an unsupervised fashion using the training datasets 716 without labelling.

In certain embodiments, using channel-specific training datasets 716 to train the predictive models 160 can permit the predictive models 160 to generate model outputs 161 and/or demand metrics 513 for the channel 170 with greater accuracy and precision. As discussed above, many different variables can impact or affect the demand in the channels 170. Additionally, the impact each variable has on the channel 170 can vary significantly. For example, negative weather conditions can heavily affect demand conditions in one channel, but may have little or no effect on the demand conditions in another channel. By using channel-specific training datasets 716, the predictive models 160 can be trained in a manner that is specific to each channel 170 and can separately learn how each variable affects the demand conditions in each channel 170.

In the model validation stage 730, the trained predictive models 160 are tested and validated, such as using validation dataset 717. Various changes can be implemented to enhance or hone the precision of the model outputs 161 and/or demand metrics 513 generated by the predictive models 160. In many embodiments, the predictive models 160 can be validated against historical data, versioned, saved and stored.

Turning ahead in the drawings, FIG. 7B is block flow diagram illustrating an exemplary deployment phase or deployment state of the predictive models 160 in accordance with certain embodiments. In this deployment phase or state, the predictive models 160 can be deployed on the user-sourced analytics platform 150 and can generate mode output 161 (e.g., demand metrics 513), which can be made accessible directly on the user-sourced analytics platform 150 and/or which can be provided to one or more client systems 140 that are interfaced with the user-sourced analytics platform 150.

In broad terms, the deployment phase of FIG. 7B can include, inter alia, the event capture stage 705, the event preprocessing stage 710, a feature generation stage 740, and a model deployment stage 745.

In the event capture stage 705, the same details described above with respect to FIG. 7A also apply generally in the deployment phase. For example, channel events 175 corresponding to the channel 170 can be received and stored in one or more databases 701 (e.g., databases 701 that are maintained by, or accessible to, the user-sourced analytics platform 150). In the deployment phase, the system is not necessarily concerned with aggregating the channel events 175, but rather is receiving and processing real-time channel events 703 that correspond to the current or real-time conditions in the channel 170.

In the event preprocessing stage 710, the same details described above with respect to FIG. 7A also apply generally in the deployment phase. Various preprocessing operations (e.g., validation, extraction, and normalization operations) can be performed on the real-time channel events 703 to conform the data to a uniform or standardized format is usable for later stages of the deployment phase.

In the feature generation stage 740, the channel features 175 are extracted and/or derived from the real-time channel events 703. For example, a separate set of channel features 721, each a feature vector 741, can be derived for each channel 170 based on the channel events 175 associated with each channel 170. Each set of channel features 721 (e.g., set 721A, 721B, . . . , 721N) can represent the current demand conditions in a corresponding channel 170. Exemplary channel features 721 are described above, but other types of channel features 721 also can be used.

In the model deployment stage 745, one or more pre-trained predictive models 160 can receive one or more of the sets of channel features 721 and utilize the channel features 721 to generate model outputs 161, such as demand metrics 513, for one or more of the channels 170. In certain embodiments, each model output 161, such as demand metrics 513, can indicate or predict the demand in a corresponding channel 170 for a current (or most recent) time period. The demand metrics 513 can be made accessible via the analytics platform (e.g., displayed on various GUIs) and/or can be transmitted to one or more client systems 140. In some embodiments, the predictive models 160 (e.g., forecasting models 830) can receive one or more prediction inputs 704 from an application, function, and/or graphical user interface (GUI) 706 associated with the user-sourced analytics platform 150. In some cases, the prediction inputs 704 can specify a specific channel 170 and a specific timeframe in a future period of time, and the predictive models 160 can forecast or predict a demand metric 513 for the channel 170 at the future point in time. In some cases, the prediction inputs 704 can identify multiple channels and multiple future timeframes, and the predictive models 160 can separately forecast or predict the demand metric 513 for each combination of inputs.

Jumping ahead in the drawings, FIG. 8B illustrates is a block diagram illustrating predictive models that can be deployed by predictive engines in the model deployment stage 745. Implementations of the predictive models trained and validated in model training 725 (e.g., as shown in FIG. 8A and described above), described above can be utilized by the predictive engines 168 to generate model outputs 161, such as demand metrics 513. The predictive engines 168 can include one or more anomaly detection engine 840, one or more consumer profiling and CTA engine 850, and/or one or more forecasting engine 860. The anomaly detection engine 840 can utilize the anomaly detection models 820 (supervised and/or unsupervised), such as the PELT change point model 823, the IF outlier detection model 825, and the NB anomaly classification model 828, which can be used alone or in combination to provide various model outputs, such as multifactor anomaly predictions 871, which can be transformed and used for downstream applications, such as by demand adjustment functions 195 and/or deployment functions 190. The consumer profiling and CTA engine 850 can utilize consumer profiling and call-to-action (CTA) models 810, such as the NB classifiers 813, GBM 815 (e.g., a GBM consumer spend regression model), and/or one or more customer segmentation models 817, which can be used alone or in combination to provide various model outputs. The model outputs can include visitor and/or local predictions 872, demographic and/or psychographic predictions 873, purchase spend predictions 874, channel-to-channel movement predictions 875, marketing conversion feedback 876, behavioral prediction feedback 877, and/or other suitable output, which can be transformed and used for downstream applications, such as by demand adjustment functions 195 and/or deployment functions 190. The forecasting engine 860 can utilize the forecasting models 830, such as time series forecasting models 833, trained for one or more channels to provide various model output, such as real-time surge quantification forecasts 878, which can include short-term and/or long-term predictions of consumer demand. Outputs from these models can be used as-is or transformed for end-user applications, such as demand adjustment functions 195 and/or deployment functions 190, which can include use in automated price adjustments, resource allocation, logistics support, a general alert system, and user notifications and incentives to drive surge, among others.

Returning to FIG. 7B, in the model deployment stage 745, the model outputs 161 (e.g., demand metrics 513 and/or outputs 871-877) can be provided to, or utilized by, one or more demand adjustment functions 195 and/or deployment functions 190. Exemplary demand adjustment functions 190 can utilize the real-time demand metrics 513 to adjust pricing in the channel 170 (e.g., to adjust pricing in particular verticals and/or to adjust pricing for particular inventory items).

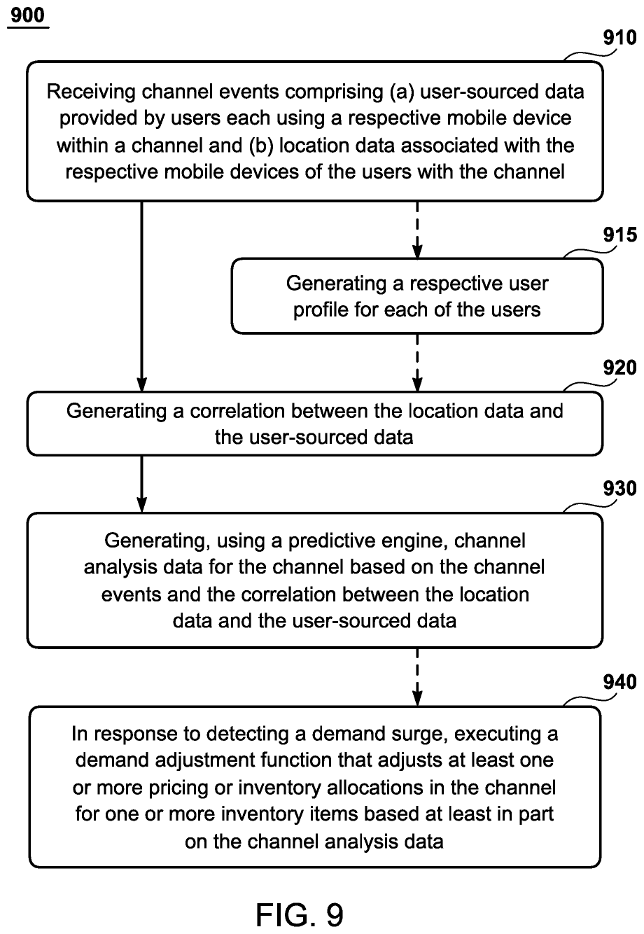

FIG. 9 illustrates a flow chart for an exemplary method 900 according to certain embodiments. Method 900 is merely exemplary and is not limited to the embodiments presented herein. Method 900 can be employed in many different embodiments or examples not specifically depicted or described herein. In some embodiments, the steps of method 900 can be performed in the order presented. In other embodiments, the steps of method 900 can be performed in any suitable order. In still other embodiments, one or more of the steps of method 900 can be combined or skipped. In many embodiments, system 100, user-sourced analytics platform 150 can be configured to perform method 900 and/or one or more of the steps of method 900. In these or other embodiments, one or more of the steps of method 900 can be implemented as one or more computer instructions configured to run at one or more processing devices 102 and configured to be stored at one or more non-transitory computer storage devices 101. Such non-transitory memory storage devices 101 can be part of a computer system such as system 100 or user-sourced analytics platform 150.

Step 910 includes receiving channel events comprising (a) user-sourced data provided by users each using a respective mobile device within a channel and (b) location data associated with the respective mobile devices of the users with the channel. In certain embodiments, the user-sourced data comprises user demographic data entered by the users. In certain embodiments, the user-sourced data comprises user preference data entered by the users. In certain embodiments, the user-sourced data comprises user transaction data entered by the users. In certain embodiments, the user-sourced data comprises reasons for actions taken or not taken by the users, as entered by the users. In certain embodiments, at least a portion of the user-sourced data is entered by a user of the users via a slider element on a mobile application running on the respective mobile device used by the user. In certain embodiments, the slider element is a multi-dimensional slider. In certain embodiments, at least a portion of the user-sourced data is entered by a user of the users selecting a selectable response option in response to a prompt presented to the user on the respective mobile device used by the user.

An optional step 915 includes generating a respective user profile for each of the users. In certain embodiments, the respective user profile is based at least in part on the user-sourced data. In certain embodiments, the user profile comprises one or more user propensities for each of the users.

Step 920 includes generating a correlation between the location data and the user-sourced data.

Step 930 includes generating, using a predictive engine, channel analysis data for the channel based on the channel events and the correlation between the location data and the user-sourced data. In certain embodiments, the channel analysis data comprises a demand prediction for the channel. In certain embodiments, the channel analysis data comprises model outputs generated the predictive engine using one or more predictive models. In certain embodiments, the one or more predictive models comprise one or more anomaly detection models. In certain embodiments, the one or more predictive models comprise one or more consumer profiling and call-to-action models. In certain embodiments, the one or more predictive models comprise one or more time series forecasting models.

An optional step 940 includes, in response to detecting a demand surge, executing a demand adjustment function that adjusts at least one of pricing or inventory allocations in the channel for one or more inventory items based at least in part on the channel analysis data.

The techniques described in this disclosure provide a technical solution (e.g., that combine location tracking and predictive technologies) for overcoming the limitations associated with known techniques. This technology-based solution marks an improvement over existing capabilities and functionalities related to processing data across multiple channels or geographic areas.

In certain embodiments, the techniques described herein can be utilized continuously at a scale that cannot be reasonably performed using manual techniques or the human mind. For example, in many embodiments, real-time information from large numbers of channels or geographic areas can be simultaneously processed and analyzed to provide real-time updates to client systems. This simultaneous processing of real-time data cannot be performed by a human mind.

Additionally, in certain embodiments, the techniques described herein solve a technical problem that arises only within the realm of computer networks, as predictive models in computer networks or architectures do not exist outside the realm of computer networks.

Various embodiments include a computerized method comprising: (1) receiving channel events comprising (a) user-sourced data provided by users each using a respective mobile device within a channel and (b) location data associated with the respective mobile devices of the users with the channel; (2) generating a correlation between the location data and the user-sourced data; and (3) generating, using a predictive engine, channel analysis data for the channel based on the channel events and the correlation between the location data and the user-sourced data.

A number of embodiments include a system comprising one or more computing devices configured to perform: (1) receiving channel events comprising (a) user-sourced data provided by users each using a respective mobile device within a channel and (b) location data associated with the respective mobile devices of the users with the channel; (2) generating a correlation between the location data and the user-sourced data; and (3) generating, using a predictive engine, channel analysis data for the channel based on the channel events and the correlation between the location data and the user-sourced data.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be a magnetic, optical, electronic, electromagnetic, infrared, or semiconductor system (or apparatus or device) or a propagation medium. The medium may include a computer-readable storage medium, such as a semiconductor or solid-state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

It should be recognized that any features and/or functionalities described for an embodiment in this application can be incorporated into any other embodiment mentioned in this disclosure. Moreover, the embodiments described in this disclosure can be combined in various ways. Additionally, while the description herein may describe certain embodiments, features, or components as being implemented in software or hardware, it should be recognized that any embodiment, feature, or component that is described in the present application may be implemented in hardware, software, or a combination of the two.

While various novel features of the invention have been shown, described, and pointed out as applied to particular embodiments thereof, it should be understood that various omissions and substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

1.-30. (canceled)

31. A method implemented via execution of computing instructions by one or more processors and stored on one or more non-transitory computer-readable storage devices, the method comprising:
providing, by the one or more processors, access over a network to a user-sourced analytics platform that includes a predictive model configured to predict demand metrics in a plurality of channels corresponding to geographic regions;
receiving, by the user-sourced analytics platform, a first set of channel events comprising location tracking data that identifies locations of computing devices within a channel, the computing devices being operated by or associated with individuals;
receiving, by the user-sourced analytics platform, a second set of channel events comprising user-sourced data that is obtained from local applications stored on the computing devices located within the channel, the user-sourced data obtained the location applications at least indicating propensities or preferences of the individuals with respect to one or more inventory items;
correlating, by the one or more processors, the user-sourced data received in the second set of channel events with the location tracking data received in the first set of channel events to identify the propensities or preferences of the individual located in the channel;
predicting, via execution of the predictive model by the one or more processors, one or more demand metrics for the channel based, at least in part, on the user-sourced data corresponding to the individuals determined to be located in the channel;
detecting, by the one or more processors, a demand surge in the channel based, at least in part on the one or more demand metrics predicted by the by the user-sourced analytics platform; and
wherein, in response to detecting the demand surge, a demand adjustment function is executed that adjusts prices or allocations for the one or more inventory items in the channel based, at least in part, on the one or more demand metrics.

32. The method of claim 31, wherein:
the predictive model comprises one or more learning models that are trained to predict the one or more demand metrics for the channel;
feature vectors are derived, at least in part, from the first set of channel events and the second set of channel events; and
the one or more one or more learning models are configured predict the one or more demand metrics using the feature vectors.

33. The method of claim 32, wherein:
the one or more learning models include at least one anomaly detection model comprising: a changepoint detection model; a PELT (pruned exact linear time) model; an outlier detection model; or IF (isolation forests) model; and
the at least one anomaly detection model predicts the one or more demand metrics for that channel based, at least in part, on feature vectors derived from the user-sourced data obtained from the local applications stored on the computing devices located within the channel.

34. The method of claim 32, wherein:
the one or more learning models include at least one time series forecasting model; and
the at least one time series forecasting model predicts the one or more demand metrics for that channel based, at least in part, on the feature vectors derived from the user-sourced data that is obtained from the local applications of the computing devices located within the channel.

35. The method of claim 31, wherein the predictive model comprises one or more profiling models trained to generate consumer profiling predictions related to the individuals detected as being located within the channel.

36. The method of claim 35, wherein the consumer profiling predictions are utilized, at least in part to predict the one or more demand metrics for the channel.

37. The method of claim 35, wherein the consumer profiling predictions generated by the one or more profiling models are utilized to interact directly with the individuals.

38. The method of claim 31, wherein the local applications stored on the computing devices enable the individuals to input or specify the user-sourced data, at least in part, by:
responding to prompts transmitted by the user-sourced analytics platform and presented via the local applications; and
providing selections via one or more slider elements presented via the local applications.

39. The method of claim 31, wherein:
the predictive model comprises a combination of learning models including at least one unsupervised learning model and at least one supervised learning model; and
the combination of learning models is utilized to generate the one or more demand metrics for the channel.

40. The method of claim 31, wherein:
a client system is interfaced with the user-sourced analytics platform and accesses the one or more demand metrics via an application programming interface (API);
the demand adjustment function is executed by the client system; and
the client system utilizes the one or more demand metrics in connection with adjusting pricing or allocations of an inventory item offered through one or more of the following: a ride hailing application; an accommodation application; a travel application; or a reservation application.

41. A system comprising:
one or more processors; and
one or more non-transitory computer-readable storage devices storing computing instructions configured to run on the one or more processors and cause the one or more processors to execute functions comprising:
providing, by the one or more processors, access over a network to a user-sourced analytics platform that includes a predictive model configured to predict demand metrics in a plurality of channels corresponding to geographic regions;
receiving, by the user-sourced analytics platform, a first set of channel events comprising location tracking data that identifies locations of computing devices within a channel, the computing devices being operated by or associated with individuals;
receiving, by the user-sourced analytics platform, a second set of channel events comprising user-sourced data that is obtained from local applications stored on the computing devices located within the channel, the user-sourced data obtained the location applications at least indicating propensities or preferences of the individuals with respect to one or more inventory items;
correlating, by the one or more processors, the user-sourced data received in the second set of channel events with the location tracking data received in the first set of channel events to determine the propensities or preferences of the individual located in the channel;
predicting, via execution of the predictive model by the one or more processors, one or more demand metrics for the channel based, at least in part, on the user-sourced data corresponding to the individuals determined to be located in the channel;
detecting, by the one or more processors, a demand surge in the channel based, at least in part on the one or more demand metrics predicted by the by the user-sourced analytics platform; and
wherein, in response to detecting the demand surge, a demand adjustment function is executed that adjusts prices or allocations for the one or more inventory items in the channel based, at least in part, on the one or more demand metrics.

42. The system of claim 41, wherein:
the predictive model comprises one or more learning models that are trained to predict the one or more demand metrics for the channel;
feature vectors are derived, at least in part, from the first set of channel events and the second set of channel events; and
the one or more one or more learning models are configured predict the one or more demand metrics using the feature vectors.

43. The method of claim 42, wherein:
the one or more learning models include at least one anomaly detection model comprising: a changepoint detection model; a PELT (pruned exact linear time) model; an outlier detection model; or IF (isolation forests) model; and
the at least one anomaly detection model predicts the one or more demand metrics for that channel based, at least in part, on feature vectors derived from the user-sourced data obtained from the local applications stored on the computing devices located within the channel.

44. The method of claim 42, wherein:
the one or more learning models include at least one time series forecasting model; and
the at least one time series forecasting model predicts the one or more demand metrics for that channel based, at least in part, on the feature vectors derived from the user-sourced data that is obtained from the local applications stored on the computing devices located within the channel.

45. The method of claim 41, wherein the predictive model comprises one or more profiling models trained to generate consumer profiling predictions related to the individuals detected as being located within the channel.

46. The method of claim 45, wherein the consumer profiling predictions are utilized, at least in part to predict the one or more demand metrics for the channel.

47. The method of claim 45, wherein the consumer profiling predictions generated by the one or more profiling models are utilized to interact directly with the individuals.

48. The method of claim 41, wherein the local applications stored on the computing devices enable the individuals to input or specify the user-sourced data, at least in part, by:
responding to prompts transmitted by the user-sourced analytics platform and presented via the local applications; and
providing selections via one or more slider elements presented via the local applications.

49. The method of claim 41, wherein:
the predictive model comprises a combination of learning models including at least one unsupervised learning model and at least one supervised learning model; and
the combination of learning models is utilized to generate the one or more demand metrics for the channel.

50. The method of claim 41, wherein:
a client system is interfaced with the user-sourced analytics platform and accesses the one or more demand metrics via an application programming interface (API);
the demand adjustment function is executed by the client system; and
the client system utilizes the one or more demand metrics in connection with adjusting pricing or allocations of an inventory item offered through one or more of the following: a ride hailing application; an accommodation application; a travel application; or a reservation application.
